(19) United States
(12) Patent Application Publication
(10) Pub. No.: US 2009/0293484 A1
(43) Pub. Date: Dec. 3, 2009

(54) GAS TURBINE COMBUSTOR AND METHOD FOR SUPPLYING FUEL TO THE SAME

(76) Inventors: Hiroshi Inoue, Mito (JP); Takeo Saito, Hitachinaka (JP); Keisuke Miura, Hitachi (JP); Kazuhito Koyama, Hitachi (JP)

Correspondence Address: MATTINGLY & MALUR, P.C., 1800 DIAGONAL ROAD, SUITE 370, ALEXANDRIA, VA, 22314, US

(21) Appl. No.: 11/865,126

(22) Filed: Oct. 1, 2007

(30) Foreign Application Priority Data
Oct. 2, 2006 (JP) 2006-270257
Sep. 20, 2007 (JP) 2007-243207

(51) Int. Cl. F02C 7/22

(52) U.S. Cl. 60/740

(57) ABSTRACT

A fuel flow path and a flow path of air for combustion are disposed coaxially to create a coaxial jet such that a fuel flow is embraced by an air flow. A large number of such fuel flow paths and air flow paths are arranged in a wall surface of a combustion chamber to create coaxial nozzle jets. Some of the flow paths of air for combustion are arranged inclinedly so as to create rotation for the stabilization of combustion and straight portions not having an inclination angle are added respectively to upstream ends of such inclined air flow paths. Fuel is jetted toward or within the straight portions.

### BACKGROUND OF THE INVENTION

1. Field of the Invention

The present invention relates to a gas turbine combustor and a method for supplying fuel to the gas turbine combustor.

2. Description of the Related Art

A diffusion combustion method and a premixed combustion method are known in the art as combustion methods for gas turbine combustors. In the diffusion combustion method, the turndown ratio from start-up to a rated load condition is large and, in order to ensure combustion stability over a wide range, fuel is injected directly into a combustion chamber. On the other hand, the premixed combustion method is a combustion method for reducing nitrogen oxides. However, the premixed combustion method involves specific unstable factors such as, for example, the entry of a flame into a premixer, causing a flashback phenomenon which leads to burnout of a structure.

In an effort to solve this problem there has been proposed a method wherein a fuel nozzle and an air nozzle opposed to each other within a combustion chamber are disposed in a substantially coaxial relation to each other and both fuel and air are supplied as a coaxial flow into the combustion chamber (see, for example, JP-A-2003-148734).

### SUMMARY OF THE INVENTION

When the diffusion combustion method is adopted a high level of NOx is produced. The premixed combustion method involves a problem related to combustion stability such as the occurrence of a flashback phenomenon and a problem related to flame stabilization at the time of start-up and partial load. In actual operation it is desirable to solve these problems simultaneously.

On the other hand, the gas turbine combustor described in JP-A-2003-148734 is of a structure wherein fuel and air are supplied as a coaxial flow into a combustion chamber, thereby making it possible to prevent the occurrence of flashback, further, with an individual flame it is difficult to maintain a flame, and mixing proceeds also within the combustion chamber before arriving at a flame-forming position, thus permitting combustion at a low level of NOx. JP-A-2003-148734 also discloses a method wherein plural coaxial jets are formed as a group to generate a rotating flow, thereby stabilizing a flame. According to this method there is provided a burner wherein the reliability of diffusion combustion and the low NOx in premixed combustion are compatible with each other. Further, JP-A-2003-148734 discloses a rotating flow generating method involving forming an air nozzle so as to have an angle of inclination relative to a main axis of the combustor and disposing the thus-inclined air nozzle concentrically around the axis of the combustor. It is disclosed therein that according to such a method not only the flame stability is improved by the rotating flow but also the fuel concentration distribution at an air nozzle outlet becomes asymmetric with respect to the axis of the air nozzle and the fuel concentration in the rotating flow which maintains the flame is kept relatively high, whereby the flame stability can be enhanced. However, due to unevenness in fuel concentration distribution, the problem of insufficient decrease in the amount of discharged NOx still remains as trade-off.

It is an object of the present invention to attain a further decrease of NOx in a gas turbine combustor.

The present invention is characterized in that an air nozzle is provided with a slant portion having an angle of inclination and a straight portion coaxial with a fuel nozzle, the straight portion being positioned on an upstream end side of the air nozzle.

According to the present invention it is possible to attain a further reduction of NOx in a gas turbine combustor.

### BRIEF DESCRIPTION OF THE DRAWINGS

FIG. 1 is a developed view of air nozzles in the first embodiment;

FIG. 2 is an explanatory diagram including an entire sectional view of a first embodiment of the present invention;

FIG. 3 is a detailed explanatory view of a nozzle portion in the first embodiment;

FIG. 4 is a developed view of air nozzles in the first embodiment;

FIG. 5 is a developed view of air nozzles in a second embodiment of the present invention;

FIG. 6 is a developed view of air nozzles in a third embodiment of the present invention;

FIGS. 7A and 7B are diagrams showing a coordinate system of each air nozzle in the first embodiment;

FIG. 8 illustrates a fuel concentration distribution which is generated in a combustion chamber by a straight portion of an air nozzle plate;

FIG. 9 illustrates a fuel concentration distribution which is generated in the combustion chamber by a slant portion of the air nozzle plate; and

FIG. 10 illustrates a fuel concentration distribution which is generated in a combustion chamber by an air nozzle plate in the first embodiment of the present invention.

### DETAILED DESCRIPTION OF PREFERRED EMBODIMENTS

When such a coaxial flow as an air flow embraces a fuel flow is formed, the fuel is mixed with the surrounding coaxial air flow after flowing into a combustion chamber and before actual contact with high-temperature gas to start combustion, thereby forming a premixture having a moderate mixing ratio. Thereafter, the fuel burns. Therefore, it is possible to effect low NOx combustion equivalent to lean premixed combustion. In this case, since the portion corresponding to a premixing pipe in a conventional premixed combustor is extremely short and the fuel concentration becomes nearly zero in the vicinity of an inner wall surface of an air nozzle, the potential of burnout by flashback is extremely low. On the other hand, a coaxial jet group in a flame maintaining area is such that a fuel-lean flame is stabilized by both a low flow velocity portion which is for maintaining a flame and a rotating flow created by an air nozzle group arranged around the low flow velocity portion and having an angle of inclination.

It is technically possible to incline an air nozzle and impart an inclination angle also to a fuel nozzle, thereby keeping fuel and air coaxial with each other. However, it is difficult to align both axes accurately and machining on the fuel nozzle side also becomes difficult. In practical use it is presumed that installing the fuel nozzle without having an inclination angle will be selected. In this case, the fuel nozzle is installed in a state in which a fuel jet and an air flow are out of axial alignment. Consequently, the fuel concentration distribution will become asymmetric and a restriction will be placed on the NOx reducing effect.

In this connection, when a straight portion not having an inclination angle is added to an upstream end portion of an air nozzle and a fuel jet is directed to the straight portion or is shot in the straight portion, it is possible to expect the effect of diminishing the asymmetry of fuel concentration caused by an angular deviation between the fuel jet axis and the air flow axis. Thus, it becomes possible to provide a combustor capable of exhibiting a satisfactory NOx reducing effect.

### First Embodiment

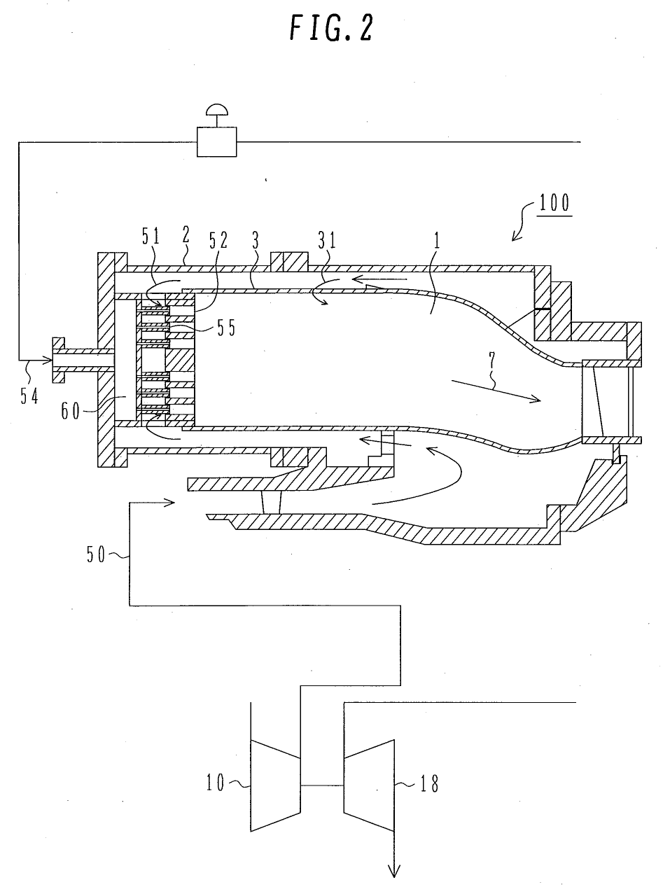

A first embodiment of the present invention will be described hereinunder with reference to the drawings. FIG. 2 is an entire sectional view of a gas turbine combustor according to this embodiment. In the same figure, the gas turbine of this embodiment is mainly composed of a compressor 10 for compressing air for combustion, a turbine 18 for driving a turbine shaft with use of combustion gas, and a combustor 100.

The compressor 10 compresses air supplied from the exterior and sends the thus-compressed air to the combustor.

Using high-temperature combustion gas produced from the combustor 100, the turbine 18 drives and rotates the turbine shaft to generate electric power.

The combustor 100 is mainly provided with a section for the supply of fuel and air, a combustor liner 3 and an outer cylinder 2. A fuel header 60 is installed inside the outer cylinder 2 of the combustor. The fuel header 60 feeds fuel 54 to a combustion chamber 1 defined within the combustor liner 3, as shown in FIG. 2. The fuel is supplied from fuel nozzles 55 projecting from the fuel header 60. In front of the fuel nozzles 55 are disposed air nozzles 52 correspondingly to and coaxially with the fuel nozzles. The air nozzles 52 are disposed on a wall surface of the combustion chamber on an upstream side of the same chamber.

Air 50 fed from the compressor 10 passes between the outer cylinder 2 and the combustor liner 3 and a portion thereof is supplied as cooling air 31 for the combustor liner 3 to the combustion chamber 1, while the remaining portion of the air passes as coaxial air 51 through the air nozzles 52 and is supplied to the combustion chamber 1. The fuel nozzles 55 are each disposed so as to be nearly coaxial with the associated air nozzle 52. With the fuel header 60, the fuel 54 recovers its pressure and the flow thereof is rendered uniform, then the fuel is supplied from a large number of fuel nozzles 55 and flows as a coaxial flow with air for combustion into the combustion chamber 1, in which it is mixed with the combustion air and forms a homogeneous and stable flame. The resulting high-temperature combustion gas 7 enters the turbine 18, does its job and then is discharged.

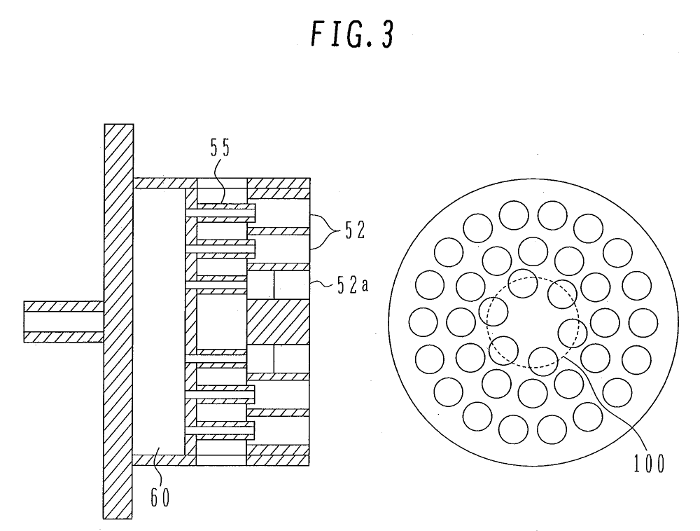

FIG. 3 shows the details of the nozzle portion. The air nozzles 52 are arranged in such a manner that the fuel supplied from each fuel nozzle 55 and the air for combustion form a coaxial flow. A large number of coaxial flows comprising fuel flows and annular air flows which embrace the fuel flows are jetted from end faces of the air nozzles 52. Fuel and air are constituted as a large number of coaxial flows of a small diameter. Such fuel and air are thoroughly mixed together in a relatively short distance, so that omnipresence of fuel does not occur and it is possible to prevent the occurrence of flashback. In this first embodiment, six air nozzles close to the burner center are given an angle of inclination relative to the burner axis in order to provide a rotating flow velocity component for enhancing the flame stability. On the other hand, air nozzles arranged at second and third stages with respect to the burner axis do not have an angle of inclination.

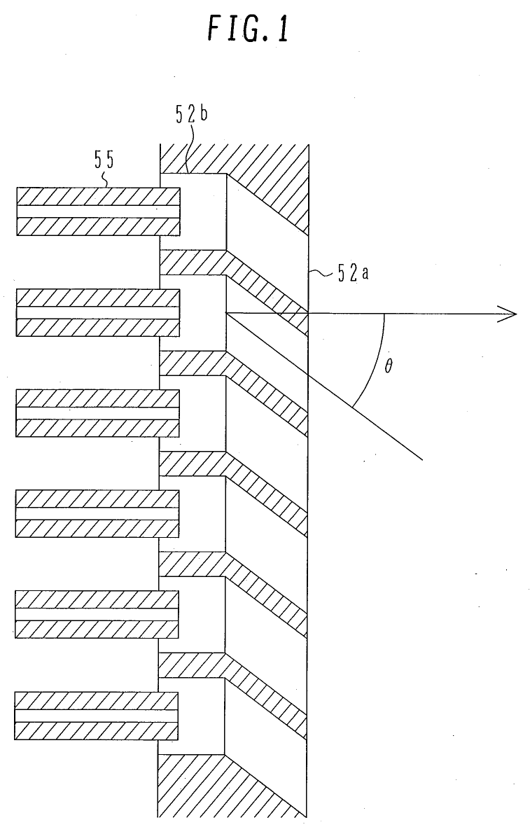

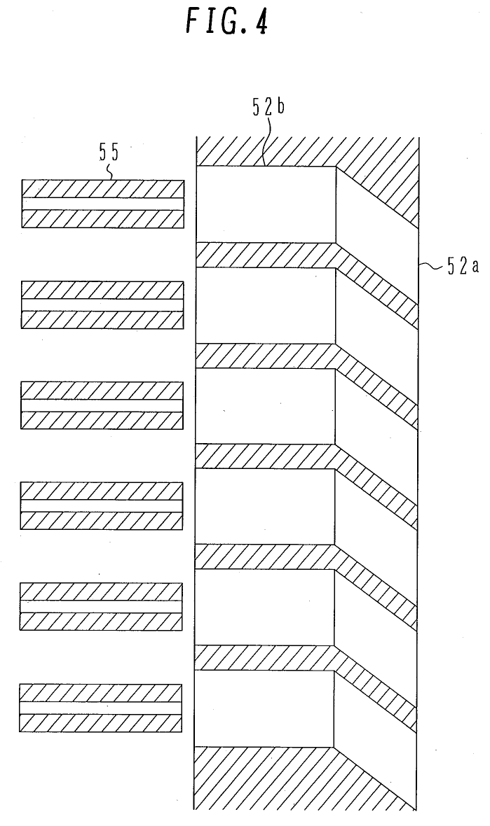

FIG. 1 is a developed plan view of air nozzle and fuel nozzle sections along a pitch circle 100 of the air nozzle group shown in FIG. 3. Each slant portion 52a is inclined at a rotational angle θ relative to the combustor axis so as to extend substantially along the pitch circle with respect to the combustor axis direction. Further, a relatively short straight portion 52b is connected to an upstream side of the slant portion 52a and the fuel nozzle 55 is disposed so as to be coaxial with the straight portion. According to such a construction, even when rotation is imparted to only the slant portion 52a, a coaxial relation between the fuel jet and the air flow can be ensured in the straight portion 52b, whereby the fuel concentration distribution at an air nozzle outlet can be made less asymmetric and hence it is possible to attain the reduction of NOx. FIG. 4 shows an example in which a longer straight portion 52b is adopted in this first embodiment. The length of the straight portion 52b can be extended without any great restriction. This is effective when further reduction of NOx is required.

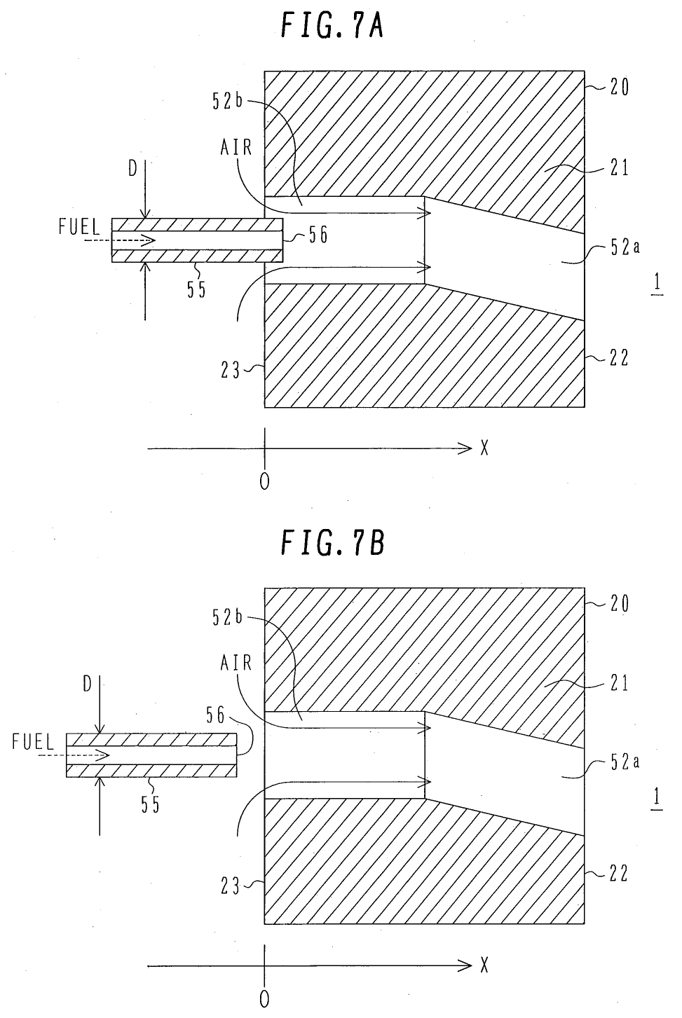

Next, a positional relation between a fuel nozzle and an air nozzle will be described with reference to FIGS. 7A and 7B. FIGS. 7A and 7B are enlarged views of a fuel nozzle and an air nozzle, in which FIG. 7A illustrates a fuel nozzle orifice as inserted into the air nozzle and FIG. 7B illustrates a separated state of the fuel nozzle orifice to an upstream side of the air nozzle. As described above, the air nozzles 52 are formed in an air nozzle plate 21 provided on a combustion chamber wall surface 20. Each air nozzle 52 has the straight portion 52b which is a hole extending in the same direction as the fuel nozzle axis and the slant portion 52a which is inclined relative to the burner axis. Thus, the slant portion 52a is also in an inclined relation to the combustor axis. The air nozzle plate 21 has a predetermined certain thickness and is composed of a combustion chamber-side wall surface 22 which is in contact with the combustion chamber wall surface 20 and a fuel nozzle-side wall surface 23 which is opposite to the combustion chamber-side wall surface and is opposed to the fuel nozzle 55.

A coordinate system using the fuel nozzle-side wall surface 23 as an origin is here considered, assuming that the direction of fuel jet from the fuel nozzle 55 is X axis. Given that the diameter of the fuel nozzle 55 is D, it is desirable that an orifice 56 of the fuel nozzle 55 be inserted into the air nozzle in the range from 0 (origin) to +D. In the case where the fuel nozzle 55 is inserted into the air nozzle 52 as in FIG. 7A, contraction of air occurs in a section where the air flow path of the air nozzle is narrowed by the fuel nozzle. On the side downstream of the orifice 56 of the fuel nozzle 55 the air flow path of the air nozzle 52 expands suddenly, so that there is obtained a rapidly expanding effect of air flow from contraction. As a result of such a rapid expansion effect of the air flow from the contraction the fuel flow jetted from the fuel nozzle 55 can also be thoroughly mixed with the air flow within the air nozzle.

However, even if the orifice 56 of the fuel nozzle 55 is inserted into the air nozzle 52 beyond +D, the effect based on the foregoing air flow contraction and expansion is not improved. Moreover, an effective portion (a non-overlapped portion of both fuel nozzle and air nozzle flow paths) of the air nozzle becomes still shorter. Therefore, the maximum distance permitting insertion of the fuel nozzle into the air nozzle is considered to be +D. Thus, in the case of the air nozzle plate 21 used in the present invention, it is preferable that the thickness of the straight portion be at least +D.

In the case where the fuel nozzle 55 is separated to the upstream side of the air nozzle 52 as in FIG. 7B, it is preferable that the fuel nozzle orifice 56 be positioned in the range from −D to 0 (origin). By separating the fuel nozzle orifice 56 to the upstream side of the air nozzle 52 it is not only possible to decrease a pressure loss but also possible to lengthen the premixing distance from the fuel nozzle orifice 56 to the fuel nozzle-side wall surface 23. However, if the fuel nozzle orifice is separated to the upstream side of the air nozzle to a greater extent than −D, the pressure loss will not be improved. Besides, it is likely that the existence time of a low velocity portion formed just before entry of the fuel jet into the air nozzle will become longer, causing flashback and spontaneous ignition. Thus, also in the positional relation between the air nozzle plate 21 and the fuel nozzle 55 according to the present invention, it is preferable that the fuel nozzle orifice 56 be positioned in the range of −D to 0 (origin) from the fuel nozzle-side wall surface 23 of the air nozzle plate 21.

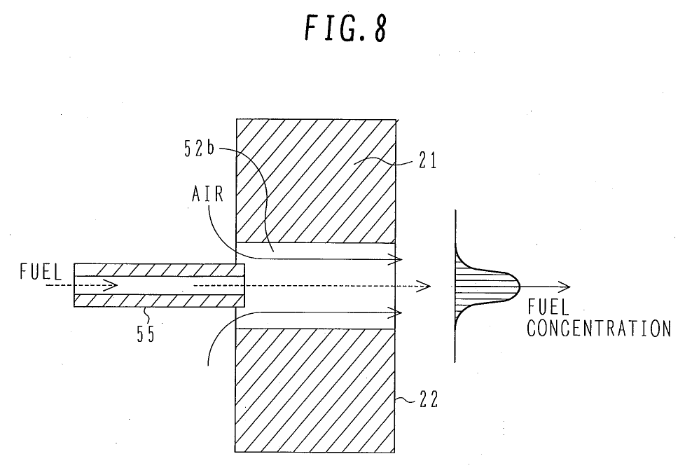

FIG. 8 shows a fuel concentration distribution created in the combustion chamber by a straight portion in the air nozzle plate. As shown in the same figure, in the case of a straight portion 52b of an air nozzle 52 whose axis is parallel to the axis of the fuel nozzle 55, a fuel concentration distribution at an air nozzle outlet (the combustion chamber-side wall surface 22 of the air nozzle plate 21) becomes an axisymmetric distribution with a high fuel concentration at the fuel nozzle axis. However, in comparison with the fuel concentration just after the jet of fuel from the fuel nozzle 55, the low flow velocity area formed near the side of the air nozzle becomes relatively low in fuel concentration. For this reason, flashback is difficult to occur from the low flow velocity area formed near the side of the air nozzle. Moreover, since a large number of small-diameter fuel nozzles and air nozzles are arranged in a dispersed manner, it is possible to suppress flashback. Further, since fuel and air are jetted dispersedly as a large number of coaxial jets, the low flow velocity area is not large inside the air nozzle and it is easy to keep a spatial distribution of fuel and air appropriately. Therefore, the fuel concentration distribution of the whole of fuel flowing into the combustion chamber can be made uniform easily and it is possible to attain the reduction of NOx.

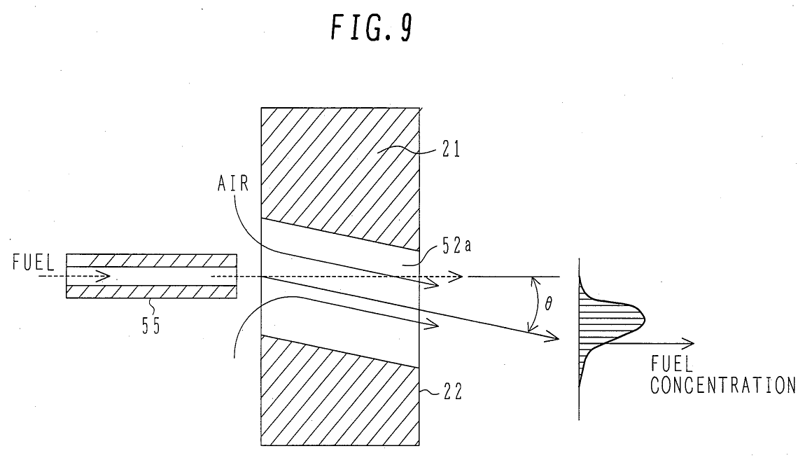

As shown in FIG. 9, in the case of a slant portion 52a of an air nozzle 52 whose axis is inclined relative to the axis of the fuel nozzle 55, a fuel jet is shot into the combustion chamber while crossing an air flow. Consequently, the fuel concentration distribution at an air nozzle outlet (the combustion chamber-side wall surface 22 of the air nozzle plate 21) becomes an asymmetric distribution.

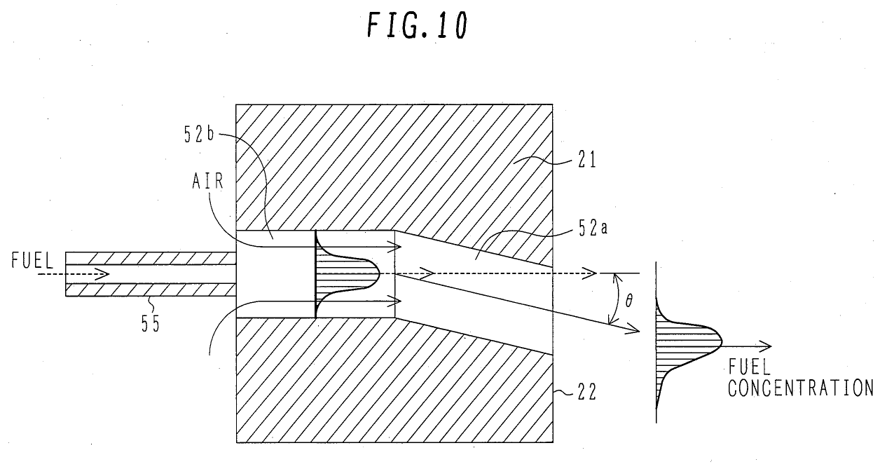

In the present invention, as shown in FIG. 10, a straight portion 52b is provided on an upstream side of the slant portion 52a, whereby the fuel concentration distribution in the straight portion 52b can be kept axisymmetric also in the combustion chamber. Moreover, since both fuel jet and air flow pass the distance corresponding to the straight portion 52b, the fuel jet is mixed with the surrounding air flow and difference in flowing velocity between the two becomes smaller. In such a decreased state of the difference in flowing velocity the fuel jet and the air flow are allowed to flow into the slant portion 52a, so that the whole of the fuel jet and the air flow can be inclined relative to the burner axis while keeping the fuel concentration distribution axisymmetric. Also the fuel concentration distribution at the air nozzle outlet (the combustion chamber-side wall surface 22 of the air nozzle plate 21) can be made less asymmetric to a great extent in comparison with that in FIG. 9 and thus it is possible to attain a further reduction of NOx.

Further, as shown in FIG. 3, the air nozzle plate 21 which forms the burner in the present invention is formed with three rows of concentric air nozzles 52 and 52a. The first row of air nozzles 52a formed on the axis side of the air nozzle plate are each provided with a slant portion and a straight portion. Fuel flows and air flows jetted from the first row of air nozzles 52a advance to the downstream side while rotating in the combustion chamber. Consequently, a recycle flow formed on the downstream side of the first row of air nozzles 52a becomes a large and stable flow, whereby the flame stability can be enhanced.

The second and third rows of air nozzles 52 are each provided with only a straight portion parallel to the fuel nozzle axis and the burner axis. Therefore, the fuel concentration distribution of fuel jetted from the second and third rows of air nozzles 52 becomes an axisymmetric distribution with a high fuel concentration at the fuel nozzle axis and with a low fuel concentration in the fuel nozzle radius direction. Consequently, ignition caused by heat from the surrounding high-temperature gas is prevented and it becomes possible to allow combustion to take place on the downstream side of the combustion chamber in which fuel and air are in a thoroughly mixed state. Thus, it is possible to attain the reduction of NOx.

### Second Embodiment

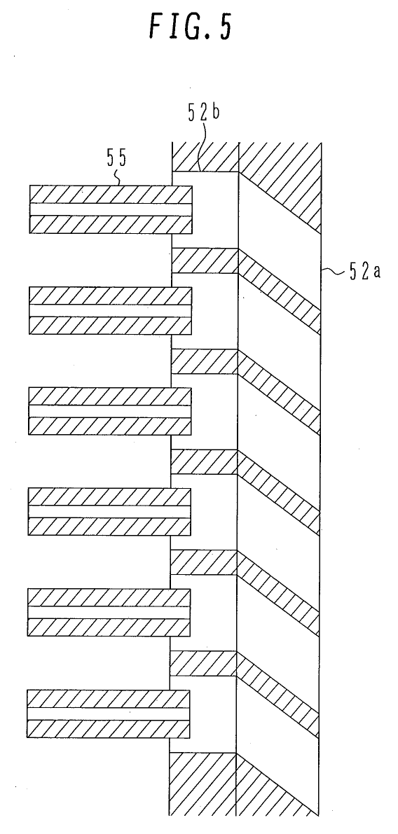

FIG. 5 is a developed view of air nozzles according to a second embodiment of the present invention. The second embodiment is different from the first embodiment in that the member which constitutes a straight portion 52b is a member separate from the member which constitutes a slant portion 52a. In the first embodiment a bent portion is present halfway of the air flow path and is considered to make the fabrication thereof somewhat difficult. In this second embodiment, since the slant portion is constituted by a member separate from the straight portion, an advantage that the respective fabrications are easy is achieved. Both members can be united and installed by not only such a mechanical joining method as bolting but also such a technique as welding or diffusion bonding.

### Third Embodiment

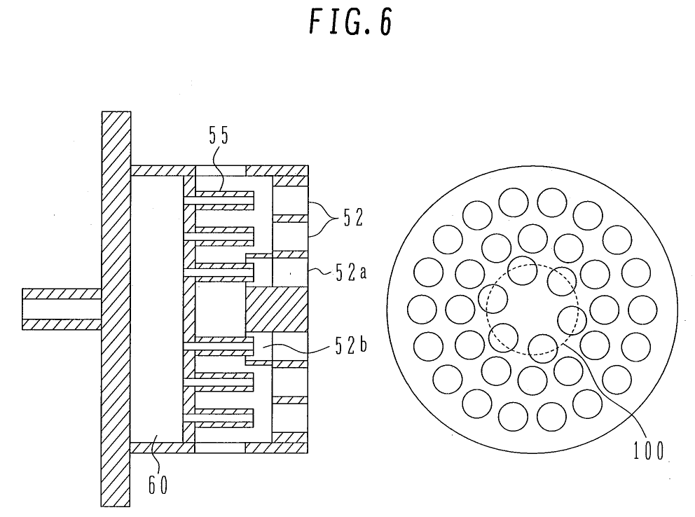

FIG. 6 illustrates a third embodiment of the present invention. The third embodiment is different from the first and second embodiments in that straight portions 52b are formed for only such slant portions 52a as are given a rotational angle. More specifically, of three rows of air nozzles formed concentrically in an air nozzle plate, the air nozzles located in the second and third rows with respect to the plate center are each provided with only a straight portion, while the air nozzles located in the first row from the plate center are each provided with both straight portion and slant portion successively from the upstream side. Therefore, a look at a sectional view (the left side in FIG. 6) of air nozzles taken along a plane including the plate center shows that air flow paths in the first row of air nozzles are formed longer than those in the second and third rows of air nozzles. Moreover, fuel nozzle-side wall surfaces in the first row of air nozzles are positioned on the upstream side with respect to fuel nozzle-side wall surfaces in the second and third rows of air nozzles. Thus, the air nozzle group not given a rotational angle becomes shorter, whereby the weight of the member which forms the air nozzles can be greatly reduced and the reduction of cost as a whole can be expected by the reduction of both material cost and machining cost.

What is claimed is:

1. A gas turbine combustor comprising:
a fuel nozzle for jetting fuel;
an air nozzle for jetting the fuel fed from the fuel nozzle and air; and
a combustion chamber into which the fuel and air jetted from the air nozzle are supplied;
wherein the air nozzle includes a slant portion having an angle of inclination and a straight portion positioned on an upstream end side of the air nozzle so as to be coaxial with the fuel nozzle.

2. The gas turbine combustor according to claim 1, wherein a member which forms the straight portion of the air nozzle is a member separate from a member which forms the slant portion of the air nozzle.

3. A gas turbine combustor according to claim 1, wherein the straight portion coaxial with the fuel nozzle is provided on only the upstream side of the air nozzle having the slant portion.

4. A method for supplying fuel to a gas turbine combustor, the gas turbine combustor comprising:
a fuel nozzle for jetting fuel;
an air nozzle for jetting the fuel fed from the fuel nozzle and air; and
a combustion chamber into which the fuel and air jetted from the air nozzle are supplied;
wherein after a coaxial straight advancing flow is formed in an axial direction of the fuel nozzle and is formed such that a straight advancing flow of the fuel jetted from the fuel nozzle is embraced by an annular air flow, the coaxial straight advancing flow is jetted into the combustion chamber inclinedly with respect to the axis of the combustor.
